(19) United States
(12) Patent Application Publication
(10) Pub. No.: US 2024/0211994 A1
(43) Pub. Date: Jun. 27, 2024

(54) SYSTEMS AND METHODS FOR TARGETED ADJUSTMENT OF MEDIA

(71) Applicant: Verizon Patent and Licensing Inc., Basking Ridge, NJ (US)

(72) Inventors: Subham Biswas, Thane (IN); Saurabh Tahiliani, Noida (IN)

(21) Appl. No.: 18/145,279

(22) Filed: Dec. 22, 2022

(51) Int. Cl. G06Q 30/0251; G06V 10/82; G06V 20/40

(52) U.S. Cl. CPC G06Q 30/0251; G06V 10/82; G06V 20/41

(57) ABSTRACT

A method may include receiving frames associated with a video stream, identifying a first object image included in at least some of the frames and masking a region, in the at least some of the frames, associated with the first object image. The method may also include receiving information identifying at least one attribute associated with a user and identifying, based on the received information, a second object image to replace the first object image. The method may further include replacing pixel values in the masked region with contextually suitable pixel values associated with the second object image and outputting the video stream with the second object image replacing the first object image in the at least some of the frames.

### BACKGROUND INFORMATION

With technological advancements, digital data consumption is increasing. As a result, advertising and promotional activity associated with digital data consumption has become a more important way for companies to reach target audiences and generate sales. However, digital advertising remains rooted in conventional advertising methods, such as providing conventional ads before or after a portion of a digital data stream.

### BRIEF DESCRIPTION OF THE DRAWINGS

FIG. 1 illustrates an exemplary system used to generate personalized ads in accordance with an exemplary implementation;

FIG. 2 is a diagram illustrating components of the system of FIG. 1 in accordance with an exemplary implementation;

FIG. 3 is a diagram of a frame associated with a digital data stream in which a portion of the frame can be identified for possible replacement in accordance with an exemplary implementation;

FIG. 4 is a block diagram of a portion of the system of FIG. 1 in accordance with an exemplary implementation;

FIG. 5 is a block diagram of components implemented in one or more of the elements illustrated in FIGS. 1-4 in accordance with an exemplary implementation;

FIGS. 6A and 6B are flow diagrams illustrating processing associated with training the neural networks of FIG. 4 in accordance with an exemplary implementation;

FIG. 7 is a diagram illustrating images associated with the processing of FIGS. 6A and 6B.

FIG. 8 is a diagram illustrating components of FIGS. 1 and 4 configured to insert advertisements in a data stream in accordance with an exemplary implementation;

FIG. 9 is a flow diagram associated with inserting personalized advertisements in a data stream in accordance with an exemplary implementation; and

FIGS. 10A and 10B are frames associated with the processing of FIG. 9 in accordance with an exemplary implementation.

### DETAILED DESCRIPTION OF EXAMPLE EMBODIMENTS

The following detailed description refers to the accompanying drawings. The same reference numbers in different drawings may identify the same or similar elements.

Implementations described herein provide personalized advertising using contextual product replacement for product images within data streams. For example, in one implementation, replacement products may be identified based on an attribute of a user, such as information received from external data feeds, such as a user's browsing history, information regarding a user's purchase history, the user's location, etc., or information provided by the user, such as user preference information. A first model, e.g., a first neural network, may process images that include masked regions to generate probable pixel values for the masked regions. A second model, e.g., a second neural network, may then use context information for pixels with respect to surrounding pixels to determine whether each pixel in an image is out of context/not contextually suitable. The first trained model may then be used to insert replacement product images within data streams in a contextually suitable manner. For example, using the context of the area in which the product image is located, including the color, intensity and gradient of surrounding pixels, the inserted replacement product images may look natural within the stream of data frames, as well as be personalized to the particular viewer, as described in detail below.

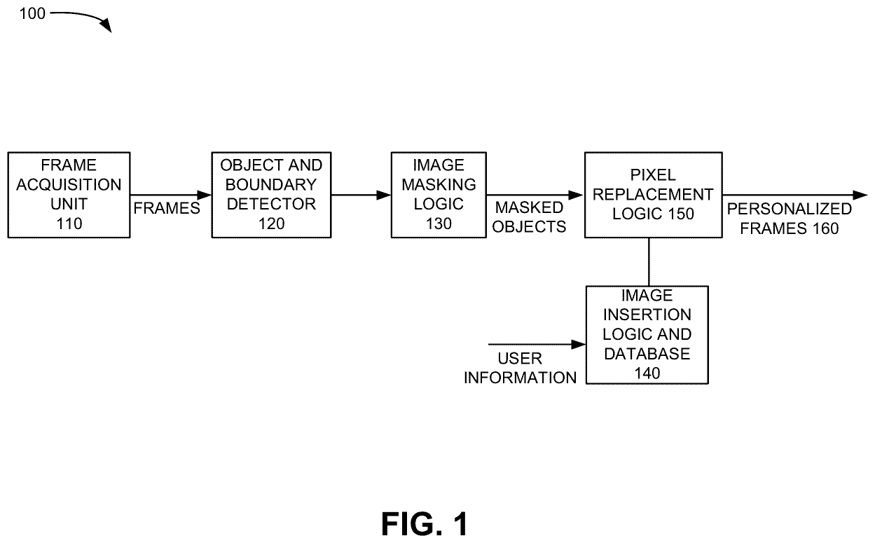

FIG. 1 is a block diagram of elements or components implemented in system 100 in accordance with an exemplary implementation. Referring to FIG. 1, system 100 includes frame acquisition unit 110, object and boundary detector 120, masking logic 130, image insertion logic and database 140 and pixel replacement logic 150. In an exemplary implementation, frame acquisition unit 110 may include a computing or processing device that receives and/or obtains video streams from any number of sources, such as television shows, movies, news media, websites, individuals, companies, etc. In some implementations, frame acquisition unit 110 may include logic to identify frames that display product images that may be appropriate for replacement within the digital data stream, as described below.

Object and boundary detector 120 may include a computing or processing device that receives the frames provided by frame acquisition unit 110 and identifies objects in the frames, whose images are suitable for replacement. For example, object and boundary detector 120 may identify consumer products, which are displayed in the data frames, whose images may be suitable for replacement by inserting other images of products that are directed to particular viewers. For example, a frame displaying an object, such as a kitchen appliance, a vehicle, a consumer item (e.g., a food item, clothes, etc.), etc., may be identified by object and boundary detector 120 as being potential items for modification/replacement. In some implementations, object and boundary detector 120 may detect words on portions of images in data frames to identify portions of images that may be appropriate for replacement. Object and boundary detector 120 may also detect the boundaries of the identified objects whose images are suitable for replacement.

Masking logic 130 may include a computing or processing device that receives information identifying objects and their corresponding boundaries, in the frames, from object and boundary detector 120. Masking logic 130 may mask the areas identified by object and boundary detector 120. The term “mask” as used herein should be construed to include changing values of pixels in an image, such as changing the pixel values to some predetermined value ranging from zero to 255 (e.g., changing each of the red, green and blue (RGB) pixel values to a predetermined value). For example, RGB values of the pixels of an identified area within a given frame may each be changed to 255, corresponding to the color white.

Image insertion logic and database 140 may include a database of images suitable for insertion into a data stream. In some implementations, image insertion logic and database 140 may include images of consumer products that may be tailored to particular viewers. For example, image insertion logic and database 140 may store images that are associated with an attribute associated with the user, such as particular user's purchasing history (e.g., a favorite cereal or coffee commonly purchased by a consumer, a type of mobile phone used by a consumer, etc.), the user's geographical location, etc. Image insertion logic and database 140 may receive preference information regarding products based on external feeds (e.g., browsing histories, search histories, purchase histories, etc.). In other instances, image insertion logic and database 140 may also receive preference information from users based on information provided by the users themselves, such as information in response to questionnaires provided to users. In such cases, the users may select to have personalized items and/or advertisements (also referred to herein as ads) inserted into data streams and the user may interface with image insertion logic and database 140 or other elements of system 100 to provide preference information. In still other implementations, image insertion logic and database 140 may receive image information based on particular geographical locations (e.g., areas of the country, different countries, etc.). For example, product images that are local to particular geographic regions may be provided to image insertion logic and database 140. Such local product images may then be inserted into frames based on the particular locations of users viewing data streams.

Pixel replacement logic 150 may include a computing or processing device that receives masked images from image masking logic 130, and product images from image insertion logic and database 140. Pixel replacement logic 150 may then insert appropriate images in place of the masked images. For example, image insertion logic and database 140 may forward images of objects that may be inserted into a masked region provided by image masking logic 130. As an example, if a frame in a movie shows a person eating a bowl of cereal at a kitchen table, pixel replacement logic 150 may replace the original image of the box of cereal with a replacement image of another brand of cereal. The inserted image may correspond to a particular brand of cereal that is favored by a particular viewer, which may be obtained from various data streams associated with the particular viewer, such as purchasing history, browsing history, etc. Pixel replacement logic 150 may then forward the frames with images that include the inserted images to provide personalized advertisements within frames in a video stream, as described in more detail below.

The exemplary configuration illustrated in FIG. 1 is provided for simplicity. It should be understood that system 100 may include more or fewer devices than illustrated in FIG. 1. For example, system 100 may include multiple frame acquisition units 110 and image insertion logic and databases 140, as well as additional elements that process the received data. In addition, system 100 may include additional elements, such as machine learning devices associated with masking portions of the images and ensuring that inserted images do not appear to be artificially generated, as described in detail below. System 100 may also include communication interfaces (e.g., radio frequency transceivers) that transmit and receive information via external networks to aid in inserting personalized images into data streams.

In addition, various functions are described below as being performed by particular components in system 100. In other implementations, various functions described as being performed by one device may be performed by another device or multiple other devices, and/or various functions described as being performed by multiple devices may be combined and performed by a single device.

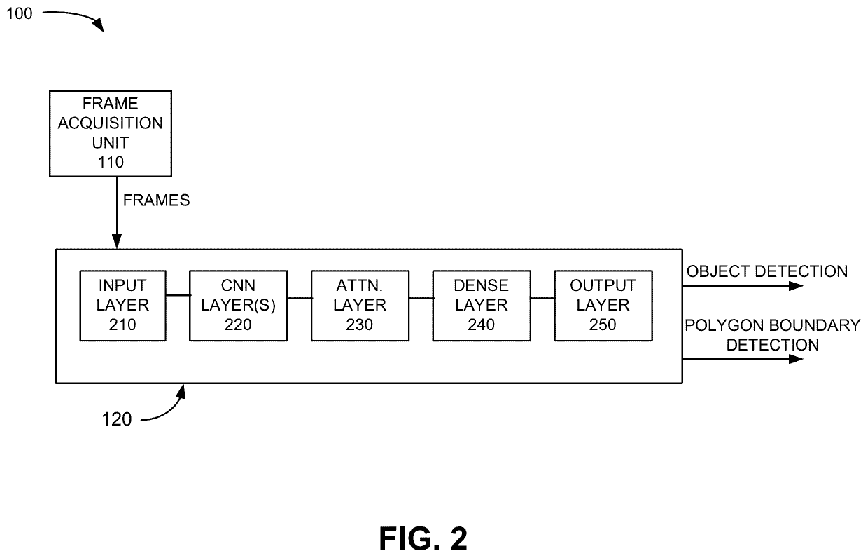

FIG. 2 illustrates elements implemented in system 100 in accordance with an exemplary implementation. For example, in one implementation, object and boundary detector 120 includes a convolutional context-aware model that may use a received linear unit (ReLU) or another type of activation function for detecting objects and the boundaries of the detected objects. The convolutional context aware model may include input layer 210, convolutional neural network (CNN) layer 220, attention layer 230, dense layer 240 and output layer 250.

Input layer 210 may include logic to receive frames from frame acquisition unit 110 and forward the frames to CNN layer 220. CNN layer 220 may include one or more deep neural networks (DNNs) that each include a number of convolutional layers and a number of kernels or filters for each layer. CNN layers 220 may use an ReLU or another type of activation function to identify context sensitive pixel values corresponding to portions of received images, as described in detail below. For example, CNN layers 220 may identify the magnitude of pixel values, and the gradient of pixel value changes with respect to surrounding pixels to determine shape and edges regarding surrounding areas, etc., to determine the context of particular pixel values with respect to surrounding pixel values.

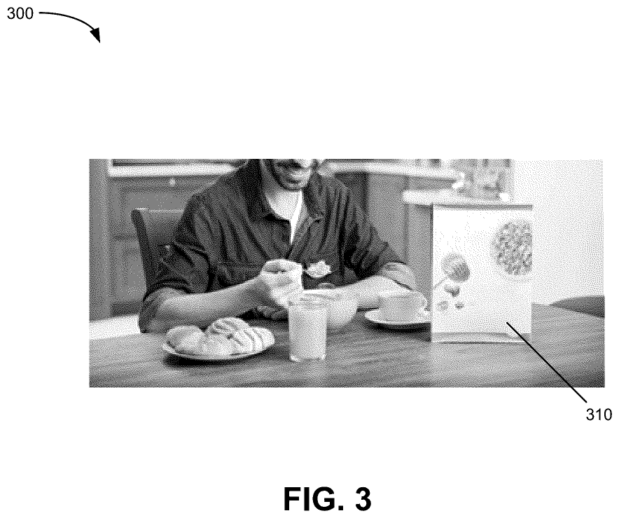

Attention layer 230 includes logic configured to emulate cognitive attention. For example, attention layer 230 may be used to identify boundaries of objects depicted in the frames. Dense layer 240 may include logic configured to classify an image in a frame. For example, dense layer 240 may identify particular types of objects shown in a frame. Output layer 250 may output information that identifies object images within frames and boundaries for the frames, such as x-y coordinates of the polygon defining the object images. The output from output layer 250 may be provided to masking logic 130, as described above. As an example, output layer 250 may output a frame or information associated with a frame, as illustrated in FIG. 3. Referring to FIG. 3, an example frame 300 includes a person sitting at a kitchen table eating a bowl of cereal. In this example, object and boundary detector 120 may output the frame along with information identifying object 310, which corresponds to a cereal box and its corresponding boundaries (i.e., the x-y coordinates defining the size and shape of the cereal box). The information identifying object 310 may be provided to image masking logic 130 and a possible image suitable for replacement, as described below. Although not described, object and boundary detector 120 may receive thousands or millions of original data frames and generate output similar to that described above for FIG. 3. The term “original frame” or “original image” as used herein refers to a frame in which images have not been replaced or digitally altered.

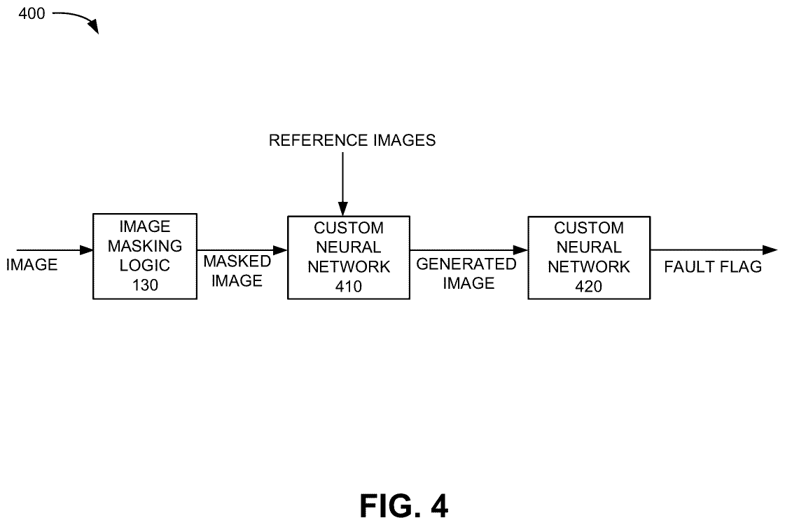

As described above, system 100 may perform pixel/image replacement with respect to frames in video streams. To avoid the replaced images from looking artificial, system 100 may perform training with respect to the use of convolutional neural networks used to insert images/pixels in video frames. Referring to FIG. 4, in an exemplary implementation, system 400 may include image masking logic 130, custom neural network 410 and custom neural network 420 (also referred to herein as neural networks 410 and 420).

As described above, image masking logic 130 may include a computing device and/or processing logic that is used to mask various portions of received frames/images. For example, in one implementation, image masking logic 130 may include a machine learning interpretability (MLI) device that randomly masks portions of input images. As described above, the term “mask” as used herein should be construed to include changing values of pixels in an image, such as changing the pixel values to any particular value. For example, assuming that an RGB color scheme is used, a value may be selected from a range of zero to 255 (e.g., changing all RGB values of a pixel to 255 corresponding to the color white, changing all RGB values of the pixel to 0 corresponding to the color black, etc.). The masked images may be input to custom neural network 410 to predict pixel values for the masked region, as described in detail below. Custom neural network 410 may also receive product reference images, such as reference images of objects, which may be inserted into frames in place of original object images.

In an exemplary implementation, custom neural network 410 may predict context-based pixel values for a masked region using a loss function based on the original image and reference image. The term context-based pixel values or contextually suitable pixel values as used herein should be construed to include determining pixel values for existing images and generated images by taking into account pixel values of surrounding pixels within the frames to ensure that generated images match or are smoothly blended into existing images. Custom neural network 420 may classify each pixel as a generated pixel or an original pixel based on the context of the surrounding pixel values using a loss function connected to the mask generator, as described in detail below. The output of custom neural network 420 may include fault flag information, as described in detail below.

Custom neural networks 410 and 420 illustrated in FIG. 4 may include additional elements that are not illustrated. For example, custom neural networks 410 and 420 may include additional neural networks and/or machine learning components/devices used to facilitate both training and the generation of images including personalized ads or object images that may be of interest to users/viewers, as described in detail below. It should also be understood that functions described as being performed by various elements in FIG. 4 may be performed by other elements/functions in other implementations.

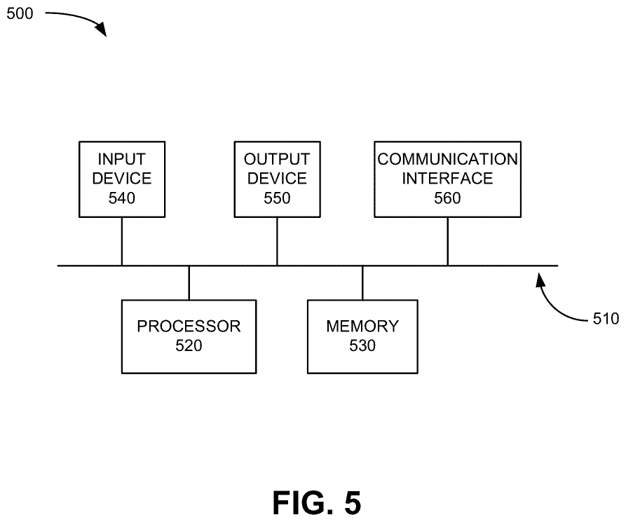

FIG. 5 illustrates an exemplary configuration of a device 500. One or more devices 500 may correspond to, be included in and/or be used to implement devices in environment 100, such as frame acquisition unit 110, object and boundary detector, image masking logic 130, image insertion logic and database 140, pixel replacement logic 150, input layer 210, CNN layer 220, attention layer 230, dense layer 240, output layer 250, custom neural network 410 and custom neural network 420. Referring to FIG. 5, device 500 may include bus 510, processor 520, memory 530, input device 540, output device 550 and communication interface 560. The exemplary configuration illustrated in FIG. 5 is provided for simplicity. It should be understood that device 300 may include more or fewer components than illustrated in FIG. 5.

Bus 510 may connect the elements illustrated in FIG. 5. Processor 520 may include one or more processors, microprocessors, or processing logic that may interpret and execute instructions. Memory 530 may include a random access memory (RAM) or another type of dynamic storage device that may store information and instructions for execution by processor 520. Memory 530 may also include a read only memory (ROM) device or another type of static storage device that may store static information and instructions for use by processor 520. Memory 530 may further include a solid state drive (SSD). Memory 530 may also include a magnetic and/or optical recording medium (e.g., a hard disk) and its corresponding drive.

Input device 540 may include a mechanism that permits a user to input information, such as a keypad, a keyboard, a mouse, a pen, a microphone, a touch screen, voice recognition and/or biometric mechanisms, etc. Output device 550 may include a mechanism that outputs information to the user, including a display (e.g., a liquid crystal display (LCD)), a speaker, etc. In some implementations, device 500 may include a touch screen display may act as both an input device 540 and an output device 550.

Communication interface 560 may include one or more transceivers that device 500 uses to communicate with other devices via wired, wireless or optical mechanisms. For example, communication interface 560 may include one or more radio frequency (RF) transmitters, receivers and/or transceivers and one or more antennas for transmitting and receiving RF data. Communication interface 560 may also include a modem or an Ethernet interface to a LAN or other mechanisms for communicating with elements in a network.

In an exemplary implementation, device 500 performs operations in response to processor 520 executing sequences of instructions contained in a computer-readable medium, such as memory 530. A computer-readable medium may be defined as a physical or logical memory device. The software instructions may be read into memory 530 from another computer-readable medium (e.g., a hard disk drive (HDD), solid state drive (SSD), etc.), or from another device via communication interface 560. Alternatively, hard-wired circuitry may be used in place of or in combination with software instructions to implement processes consistent with the implementations described herein. Thus, implementations described herein are not limited to any specific combination of hardware circuitry and software.

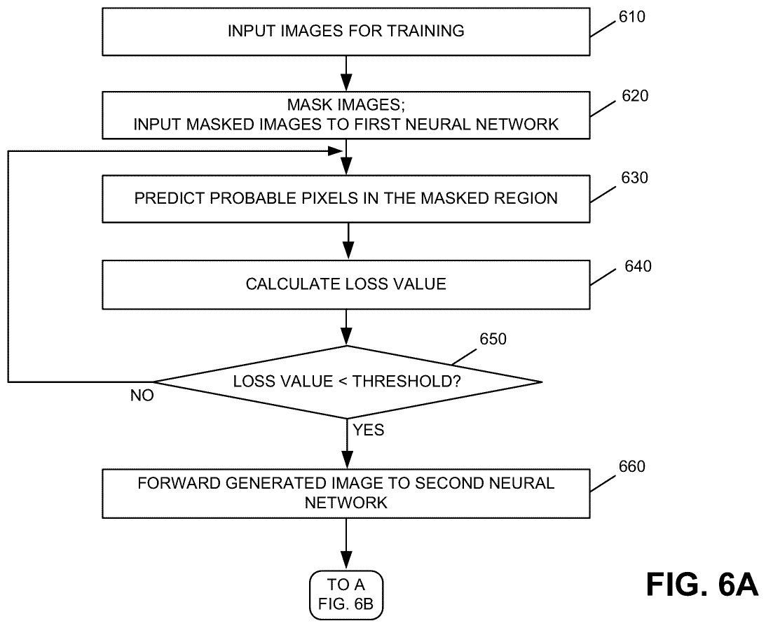

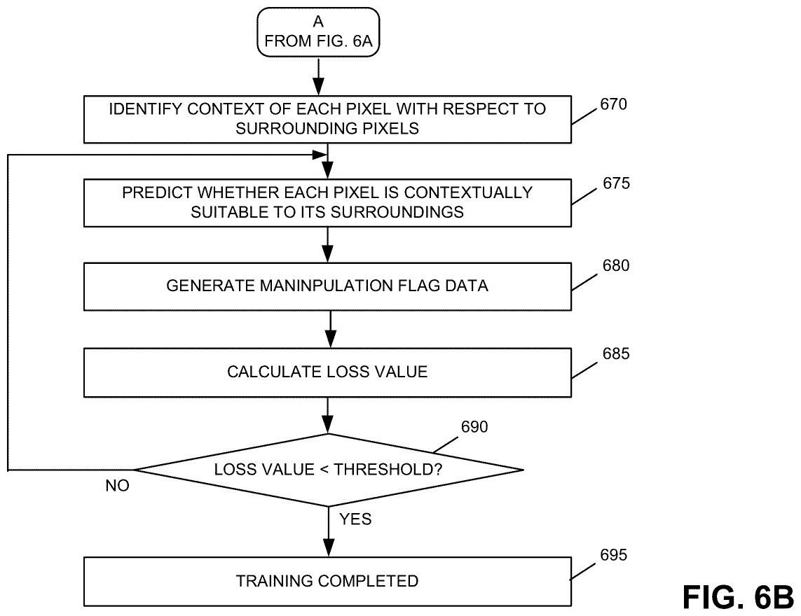

FIGS. 6A and 6B are flow diagrams illustrating processing associated with training neural networks 410 and 420 in accordance with an exemplary implementation. Processing may begin by inputting original images to image masking logic 130 (block 610). Image masking logic 130 may then mask various portions of the original image (block 620). For example, in one implementation, image masking logic 130 may randomly mask (i.e., select) a portion of each of the received images, such as randomly select images of objects within a frame. In other implementations, image masking logic 130 may mask received images based on predefined rules. For example, a masking rule may indicate that a configurable portion of an image, such as 15-25% of an image, should be masked in a random manner. Another rule may indicate that particular colors in an image (e.g., red, blue, etc.) should be masked. Still other rules may indicate that particular items in an image, or features in an image determined to be prominent or important should be masked. A prominent or important feature may be, for example, an image of an object/product located in the frame, an element located in a central portion of an image, such as a consumer product image.

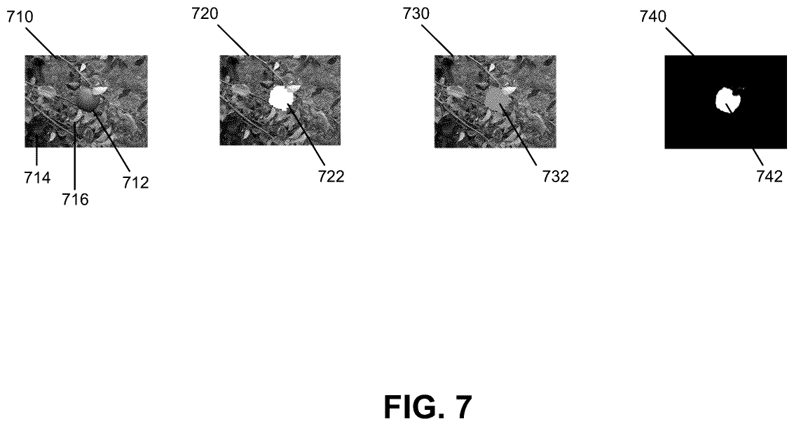

As an example, suppose that an image depicts a portion of an apple tree, as illustrated in image 710 in FIG. 7. Referring to FIG. 7, image 710 may include a red apple image 712 located in a center portion of image 710, one or more other apple images, such as apple image 714, leaves 716 on the apple tree image, etc. In this example, assume that image masking logic 130 masks the region/pixels corresponding to apple 712, as represented by image 720 in FIG. 7. Referring to FIG. 7, image masking logic 130 may mask region 722 by setting the RGB values of the pixels in region 722 to, for example, 255, which corresponds to the color white. In other implementations, image masking logic 130 may mask region 722 by setting each of the color components values of the pixels values to some other value (e.g., zero, which corresponds to the color black). In each case, image masking logic 130 may not mask/modify the remaining portions of image 720. Image masking logic 130 may input the masked image to neural network 410 (block 620).

Neural network 410 may process the masked image and learn or identify the context of each pixel with respect to its surrounding pixels. For example, neural network 410 may identify the magnitude of each color component of the pixel value (e.g., a value from 0 to 255 for a black and white image, or red, green and blue values from 0 to 255 for color images). Neural network 410 may also identify the gradient of the pixel value changes to determine the shape of elements, such as the shape and edges of surrounding areas or object images. For example, in this example, neural network 410 may identify the shape and edges of leaves on the apple tree based on each pixel value and the values of the surrounding pixels. For example, the pixels that define the leaves would be expected to have similar pixel values/colors, as opposed to pixels that define the branches of the apple tree. Neural network 410 may also determine that the color of apple image 712 would be expected to be similar to the color of apple image 714 in image 710. Neural network 410 may further use the gradient of pixel value changes to identify the shape of objects, such as the shape of an apple, the shapes of branches and leaves, etc. For example, the pixels associated with apples would be expected to have similar shapes. Neural network 410 may then use the identified context with respect to the pixel values to predict probable pixel values in the masked region (block 630).

Continuing with the example in FIG. 7, assume that neural network 410 predicts that probable pixel values for masked region 722 correspond to an orange color. In this scenario, neural network 410 generates an orange color value for pixels in masked region 722, as illustrated by region 732 in image 730. That is, region 732 in image 730 is predicted to be orange in color. Neural network 410 may also include a loss function to calculate the difference between the actual pixel values associated with apple 712 in image 710 that has been masked, and the predicted pixel values illustrated in region 732 of image 730 (block 640).

Neural network 410 may then determine if the loss value is less than a predetermined threshold (block 650). If the loss value is not less than the threshold (block 650-no), neural network 410 may back-propagate this learning information to elements of neural network 410 and the process is repeated. That is, blocks 630-650 are repeated, new predictions of probable pixel values are made and new loss values are determined. If, however, the loss value is less than the threshold (block 650-yes), neural network 410 forwards generated image 730 to neural network 420 (block 660). In this way, neural network 410 performs multiple iterations until the loss value with respect to probable pixel values for masked regions is minimal.

Neural network 420 (i.e., the second neural network in this training environment) receives the generated image and learns or identifies context of each pixel with respect to its surrounding pixels (FIG. 6B, block 670). For example, neural network 420 may identify the magnitude of each pixel value to attempt to understand or determine the nature of various colors and/or color changes. Neural network 420 may also examine each pixel with respect to the gradient of the pixel value changes to understand or determine shapes associated with objects (e.g., the shape of an apple), as well as color changes within an object image.

Neural network 420 may then use this information to predict whether each pixel is contextually suitable with respect to its surrounding pixels (block 675). For example, neural network 420 may identify the magnitude of the predicted pixel values, the gradient of changes of the pixel values with respect to neighboring pixel values, etc., as well as compare the predicted pixel values to the pixel values of surrounding areas that were not masked. If a pixel is not contextually suitable to its surroundings, neural network 420 generates a flag for that pixel (block 680). Neural network 420 may then generate manipulation flag data, as illustrated in image 740 in FIG. 7. Referring to FIG. 7, image 740 includes a white area 742 surrounded by black areas. This indicates that neural network 420 has output manipulation flag values of, for example, 1 corresponding to white area 742, indicating that pixels in area 742 are not contextually suitable. The remaining areas of image 740 are shown in black indicating that neural network 520 has output flag values of, for example, zero. The zero value indicates that a pixel is contextually suitable to its surrounding pixels.

Neural network 420 may also include a loss function to calculate the difference between the pixels known to have been masked (i.e., region 722 in image 720) with the out-of-context data corresponding to region 742 in image 740 (block 685). Neural network 420 may then determine if the loss value is less than a predetermined threshold (block 690). If the loss value is not less than the threshold (block 690-no), neural network 420 may back-propagate this learning information to elements of neural network 420 and the process is repeated. That is, blocks 675-690 are repeated. If, however, the loss value is less than the threshold (block 690-yes), neural network 420 determines that training with respect to images 710-740 has been completed (block 695). In this manner, neural network 420 performs multiple iterations with respect to images generated by neural network 410 until the loss value (for neural network 420 for the image) is minimal, indicating that training for an image has been completed.

Training of neural networks 410 and 420 may continue in this manner until a suitable number of images, such as millions of images, have been processed. Trained neural network 410 may then be used to insert various product-related images into original data frames to generate a personalized advertisement experience for users in which the inserted advertisements appear naturally within the images, as described in detail below.

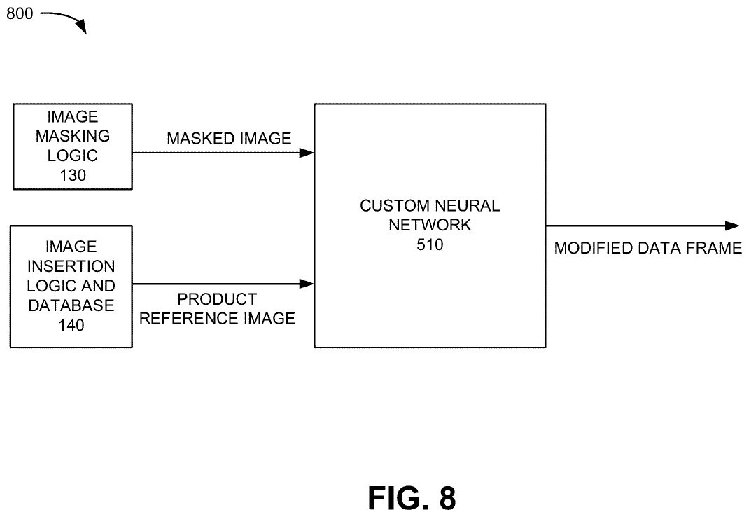

As described above, neural networks 410 and 420 may be trained to identify the context of each pixel with respect to its surrounding pixels. Once neural networks 410 and 420 have been trained, neural network 410 may be used to insert images into frames. FIG. 8 is a block diagram of a elements of a system 800 with respect to making inferences or contextually aware determinations for replacing masked images with product reference images in accordance with an exemplary implementation. Referring to FIG. 8, system 800 includes image masking logic 130, image insertion logic and database 140 and custom neural network 410.

Image masking logic 130 may input frames that include masked portions to custom neural network 410. Image insertion logic and database 140 may input reference product images to neural network 410. Custom neural network 410 may insert the product reference image into the masked frame, and output the frame with the product reference image. The output frame may be personalized to particular viewer(s) based on one or more attributes of a user, such as information received regarding viewers preferences and habits, the geographical location of the user, etc., as described in more detail below.

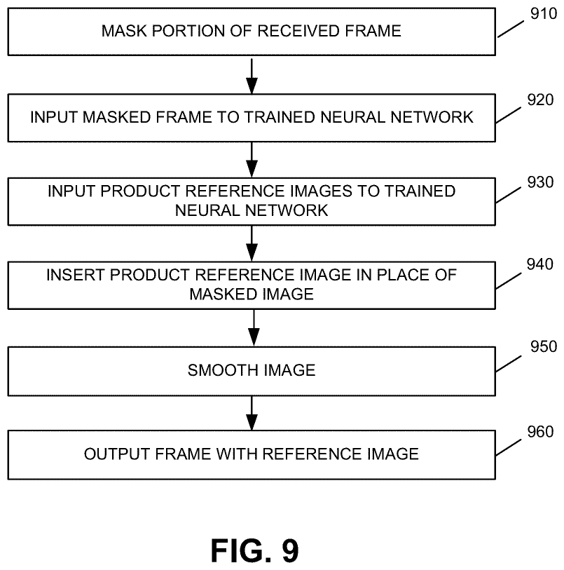

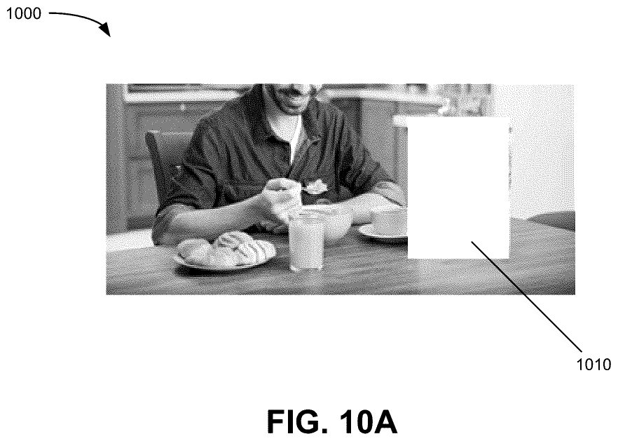

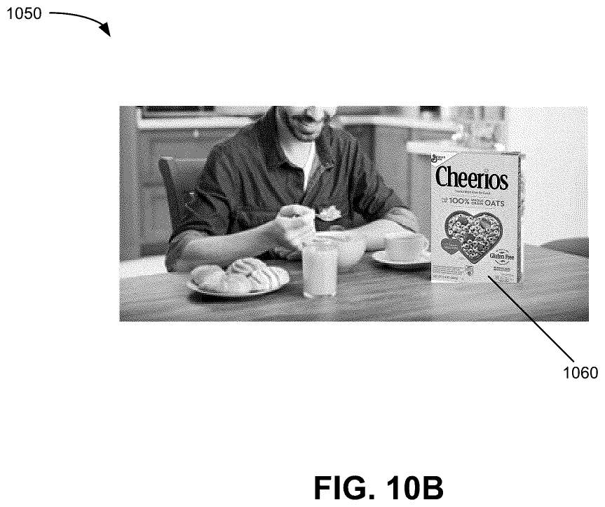

FIG. 9 is a flow diagram illustrating exemplary processing associated with inserting images into data frames in accordance with an exemplary implementation. Processing may begin by frame acquisition unit 110 forwarding an input frame to frame masking logic 130. Frame masking logic 130 may then identify items/objects of interest and mask the object images (block 910). In this example, assume that the frame shows a person eating breakfast and a box of breakfast cereal, as illustrated in FIG. 3. Continuing with this example, image masking logic 130 may identify and mask the image of the box of cereal, as illustrated in FIG. 10A. For example, image masking logic 130 may be configured to identify certain types of image objects, such as identifying images and/or image labels (e.g., the word “cereal” in this example) corresponding to consumer objects. Referring to FIG. 10A, area 1010 corresponding to the box of cereal is masked (e.g., the RGB color components of each of the pixels are assigned values of 255).

Image masking logic 130 may then input the masked frame to neural network 410 (block 920). For example, the masked frame 1000 may include information identifying masked region 1010, including information identifying coordinates of the masked region 1010, a type of product shown in the masked region (e.g., a box of cereal), the spatial orientation of the product, as well as other information to facilitate insertion of a replacement image.

Image insertion logic and database 140 may also input product reference images to neural network 410 (block 930). For example, assume that image insertion logic and database 140 stores reference images of a number of different types of cereals. Further assume that image insertion logic and database 140 has obtained data feeds from external databases, search engines, browsing and/or purchase history databases, etc., indicating particular preferences with particular users. In this example, image insertion logic and database 140 may forward an image of a particular brand of cereal based on a particular user's preference. In other implementations, image insertion logic and database 140 may identify overall preferences for large groups of consumers based on a particular city, region, country, etc. For example, if the most popular cereal in a particular area or region in a country is Brand X, or a most popular mobile phone is Brand Y, image insertion logic and database 140 may identify an image associated with Brand X for a cereal box, and/or Brand Y with respect to a mobile phone, based on the location of a particular user to whom the modified data frames will be provided.

In each case, image insertion logic and database 140 may forward the selected replacement image to neural network 410. Neural network 410 may identify the boundaries of masked object image (i.e., masked area 1010) and insert the selected replacement product image in place of the masked area (block 940). For example, neural network 410 may insert an image of a box of Cheerios® cereal in the previously masked area, as illustrated in frame 1050 in FIG. 10B. Referring to FIG. 10B, the image of the box of Cheerios® is inserted into frame 1050 at area 1060.

Neural network 410 may also smooth the image using contextually aware logic, as described above (block 950). For example, neural network 410 may modify edge portions of the image 1060 to ensure that image 1060 does not look artificially placed with respect to surrounding pixels. Neural network 410 may then output the frame with the reference image (block 960). In this manner, system 100 may provide targeted advertising to viewers. That is, each viewer may receive differently modified frames based on his/her preferences.

In addition, neural networks 410 and/or 420 may generate pixels regarding the replacement object image that takes into account the spatial and/or temporal orientation of the product within the original frames. For example, if the product is oriented vertically in the original frames (e.g., the cereal box in FIG. 3), neural networks 410 and/or 420 take into account the orientation of the image so that the inserted product image is consistent with respect to the orientation in the original frame. In addition, if the orientation of the image in the original frames changes, such as the box of cereal is picked up and then placed on its side (e.g., is oriented horizontally with respect to the table), neural networks 410 and/or 420 will ensure that the generated replacement image (e.g., the cereal box) in each of the replacement images is oriented in accordance with the orientation in the original frames. In this manner, by taking into account spatial/temporal orientation, the replacement images in the frames will be inserted based on the context/original orientation in the frames. This enables the replacement images within the frames to look natural and not artificially generated, even when the original image dynamically moves in consecutive frames.

Implementations described herein provide personalized advertising using contextual product replacement images for product images within data streams. For example, using attribute information associated with a user, which may include information received from external data feeds, such as a user's browsing history, purchase history, location information, etc., or information provided by the user, such as user preference information, a personalized advertising experience may be provided. In addition, using network models that are trained using context of pixels in an image with respect to surrounding pixels, enable inserted items/product images to appear natural within a data stream. This may allow a service provider to provide an advertising system that provides personalized advertisements in an automated manner. That is, the system may be implemented in any type of data stream, such as television shows, movies, web feeds, augmented or virtual reality feeds, etc., as well as be used with any types of product images.

The foregoing description of example implementations provides illustration and description, but is not intended to be exhaustive or to limit the embodiments to the precise form disclosed. Modifications and variations are possible in light of the above teachings or may be acquired from practice of the embodiments.

For example, features have been described with respect to randomly masking portions of images during training or masking images based on particular rules. In some implementations, the layers, kernels and/or filters of the neural networks described above may also be customized based on the particular images or portions of images that are of interest.

In addition, features have been mainly described above with respect to inserting replacement images into a stream of data frames. In other implementations, single images may be processed in a similar manner to provide replacement images within the single image. For example, if an image is associated with an advertisement for a kitchen appliance, but the image includes a box of cereal on a counter top, the image of the box of cereal may be replaced with an alternative image, as described above.

Further, while series of acts have been described with respect to FIGS. 6A, 6B and 9, the order of the acts may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving a plurality of frames associated with a video stream;
identifying a first object image included in at least some of the plurality of frames;
masking a region, in the at least some of the plurality of frames, associated with the first object image;
receiving information identifying at least one attribute associated with a user;
identifying, based on the received information, a second object image to replace the first object image;
replacing pixel values in the masked region with contextually suitable pixel values associated with the second object image; and
outputting the video stream with the second object image replacing the first object image in the at least some of the plurality of frames.

2. The method of claim 1, further comprising:
identifying, based on the received information, items of interest associated with the user, wherein the identified items of interest include an object depicted by the second object image.

3. The method of claim 2, wherein the receiving information comprises at least one of:
receiving information from an external data source identifying characteristics or preferences for the user, or
receiving information input by the user, wherein the information input by the user includes preferences for the user.

4. The method of claim 1, further comprising:
receiving a plurality of images to train a first neural network;
masking a portion of each of the plurality of images;
inputting the masked images to the first neural network;
generating, by the first neural network, probable pixel values for pixels located in the masked portion of each of the plurality of images;
forwarding the images including the probable pixel values to a second neural network;
determining, by the second neural network, whether each of the probable pixel values is contextually suitable; and
identifying pixels, in each of the plurality of images, that are not contextually suitable.

5. The method of claim 4, wherein the masking a portion of each of the plurality of images comprises:
masking a random portion of each of the plurality of images.

6. The method of claim 4, wherein the masking a portion of each of the plurality of images comprises:
masking a predetermined percentage of each of the plurality of images.

7. The method of claim 4, wherein the masking a portion of each of the plurality of images comprises at least one of:
identifying products shown in each of the plurality of images, and
masking portions of each of the plurality of images corresponding to the identified products.

8. The method of claim 1, wherein the replacing pixel values comprises:
identifying, by a neural network, pixel values associated with a received image; and
outputting pixels values associated with the received image for the masked region.

9. The method of claim 1, further comprising:
outputting, based on the received video stream, different video streams to a plurality of users, wherein the different video streams include different object images in place of the first object image.

10. A system, comprising:
at least one processing device configured to process video streams, wherein the at least one processing device is configured to:
receive a plurality of frames associated with a video stream;
identify a first object image included in at least some of the plurality of frames;
mask a region, in the plurality of frames, associated with the first object image;
receive information identifying at least one attribute associated with a user;
identify, based on the received information, a second object image to replace the first object image;
replace pixel values in the masked region with contextually suitable pixel values associated with the second object image; and
output the video stream with the second object replacing the first object image in the at least some of the plurality of frames.

11. The system of claim 10, wherein the at least one processing device is further configured to:
identify, based on the received information, items of interest associated with the user, wherein the identified items of interest include an object depicted by the second object image.

12. The system of claim 10, wherein when receiving information, the at least one device is further configured to:
receive information from an external data source identifying characteristics or preferences for the user, or
receive information input by the user, wherein the information input by the user includes preferences for the user.

13. The system of claim 10, wherein the at least one processing device is configured to implement a first neural network and a second neural network, wherein the at least one processing device is further configured to:
receive a plurality of images to train a first neural network;
mask a portion of each of the plurality of images;
input the masked images to the first neural network;
generate, by the first neural network, probable pixel values for pixels located in the masked portion of each of the plurality of images;
forward the images including the probable pixel values to a second neural network;
determine, by the second neural network, whether each of the probable pixel values is contextually suitable; and
identify pixels, in each of the plurality of images, that are not contextually suitable.

14. The system of claim 13, wherein when masking a portion of each of the plurality of images, the at least one processing device is configured to at least one of:
mask a random portion of each of the plurality of images; or
mask a predetermined percentage of each of the plurality of images.

15. The system of claim 13, wherein when masking a portion of each of the plurality of images, the at least one processing device is configured to:
identify products shown in each of the plurality of images, and
mask portions of each of the plurality of images corresponding to the identified products.

16. The system of claim 10, wherein when replacing pixel values, the at least one processing device is configured to:
identifying pixel values associated with a received image; and
output pixels values associated with the received image for the masked region.

17. The system of claim 10, wherein the at least one processing device is further configured to:
output, based on the received video stream, different video streams to a plurality of users, wherein the different video streams include different object images in place of the first object image.

18. A non-transitory computer-readable medium having stored thereon sequences of instructions which, when executed by at least one processor, cause the at least one processor to:
receive a plurality of frames associated with a video stream;
identify a first object image in at least some of the plurality of frames;
mask a region, in the at least some of the plurality of frames, associated with the first object image;
receive information identifying at least one attribute associated with a user;
identify, based on the received information, a second object image to replace the first object image;
replace pixel values in the masked region with contextually suitable pixel values associated with the second object image; and
output the video stream with the second object image replacing the first object image in the at least some of the plurality of frames.

19. The non-transitory computer-readable medium of claim 18, wherein the instructions further cause the at least one processor to:
identify, based on the received information, items of interest associated with the user, wherein the identified items of interest include an objected depicted by the second object image.

20. The non-transitory computer-readable medium of claim 18, wherein when receiving information, the instructions further cause the at least one processor to at least one of:
receive information from an external data source identifying characteristics or preferences for the user, or
receive information input by the user, wherein the information input by the user includes preferences for the user.
